(19) United States
(12) Patent Application Publication
(10) Pub. No.: US 2009/0244915 A1
(43) Pub. Date: Oct. 1, 2009

(54) INTERLOCKING SYSTEM FOR HANGING DECORATIVE LIGHTS AND FIXTURES

(76) Inventor: James M. Cooper, Layton, UT (US)

Correspondence Address: JAMES M. COOPER, 188 EAST 1375 NORTH, LAYTON, UT, 64041, US

(21) Appl. No.: 12/416,910

(22) Filed: Apr. 1, 2009

Related U.S. Application Data
(60) Provisional application No. 61/041,253, filed on Apr. 1, 2008.

(51) Int. Cl. F21S 8/00

(52) U.S. Cl. 362/432

(57) ABSTRACT

A system of interlocking, rigid or semi-rigid, components which when connected provide a modular, easy-to-install, direct, decorative, lighting system.

### RELATED APPLICATION

This application claims the benefit of U.S. Provisional Patent Application No. 61/041,253, filed Apr. 1, 2008, which is herein incorporated by reference in its entirety.

### BACKGROUND OF THE INVENTION

Outdoor decorative lighting of the type that is typically hung during the holidays has typically been comprised of light strings which when hung do not provide uniform lighting unless each bulb is individually secured using clips or other means. Individually securing each bulb is a time-consuming effort.

This purpose of this invention is to provide a lighting system that can be quickly and easily installed to provide uniform, direct, decorative lighting without having to secure each bulb individually. Furthermore, the invention solves the problem of tangled wires as the wiring is embodied within rigid or semi-rigid components.

### DETAILED DESCRIPTION OF THE INVENTION

A system of interlocking components, end caps, plugs, sockets, mounting brackets, connectors, light bulbs and etcetera, as defined below, together comprising a simplified means of hanging direct, decorative lighting. Each interlocking component is of varying or uniform length to be hung on various surfaces—each component having an internal cavity through which an electrical conduit is run. Each component has a pair of prongs, or other male conductors on one end and a matching pair of female receptacles on the other end. Each component has a series of decorative lighting sockets (such as, but not limited to C7 or C9, etc) that are connected via the internal electrical conduit. Additionally, on each end of the components is a mechanism for snapping, hooking, or otherwise connecting the component to another component in such a manner as to allow the continuation of the electrical conduit from component to component. Also specified are end caps and for terminating each component facilitating the completion of the electrical circuit. Also included are pairs of end caps connected by a wire to allow the components to be connected via a flexible wire rather than a fixed, ridged connection to another component—thus allowing the components to connect around corners or at various angles. Furthermore, end caps are included that are connected to a length of cord terminated by an electrical plug for connecting to standard electrical outlets. Also included are various mechanical or magnetic clips to be attached to each component for hanging on various surfaces via varied means. These various clips would allow the components to be hung on eaves, rain gutters, walls, etc. Also specified is mounting hardware for receiving said clips including magnetic or mechanical receptacles. Also included are other components that can be connected to each component, continuing the electrical circuit, and providing decoration such as illuminated or non-illuminated letters or words, illuminated or non-illuminated designs (such as stars, birthday cakes, etc.), motorized gadgets, etc. such that each of these devices can be plugged into the system between any two components (or between a component and an end cap).

### BRIEF DESCRIPTION OF THE DRAWINGS

The attached images demonstrate a sample implementation of the invention. Below is a description of the images:

FIG. 1: Complete, three dimensional assembly including 2-foot rail, male and female ends, sockets, L-Bracket, and spacer.

FIG. 2: Two-dimensional, two-foot rail specifications showing stamp-out for sockets.

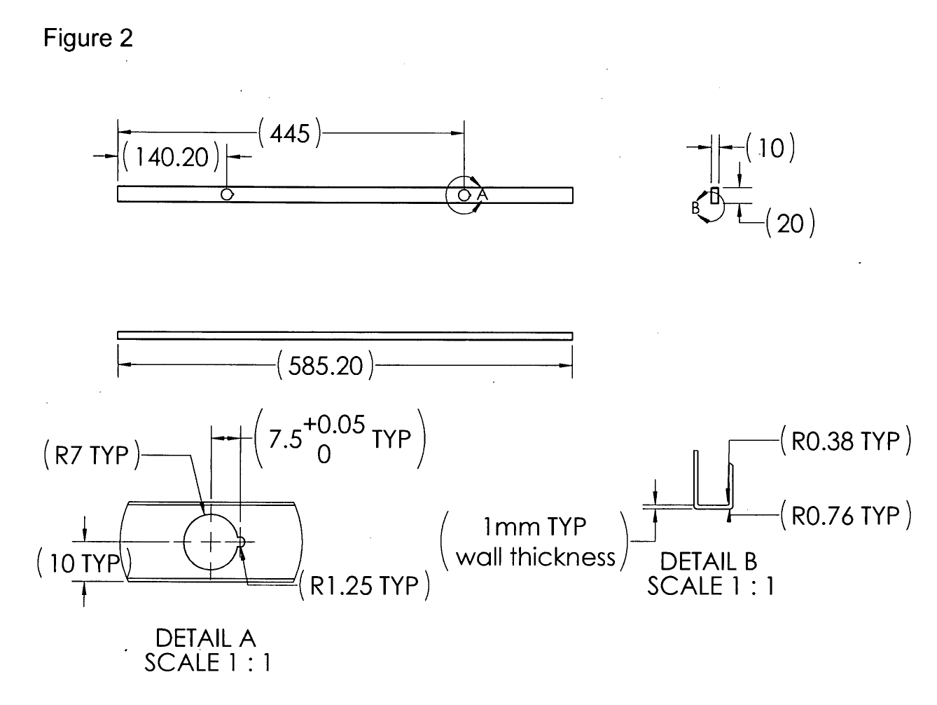

FIG. 3: Three-dimensional female end which inserts into one end of rail.

FIG. 4: Two-dimensional female specifications.

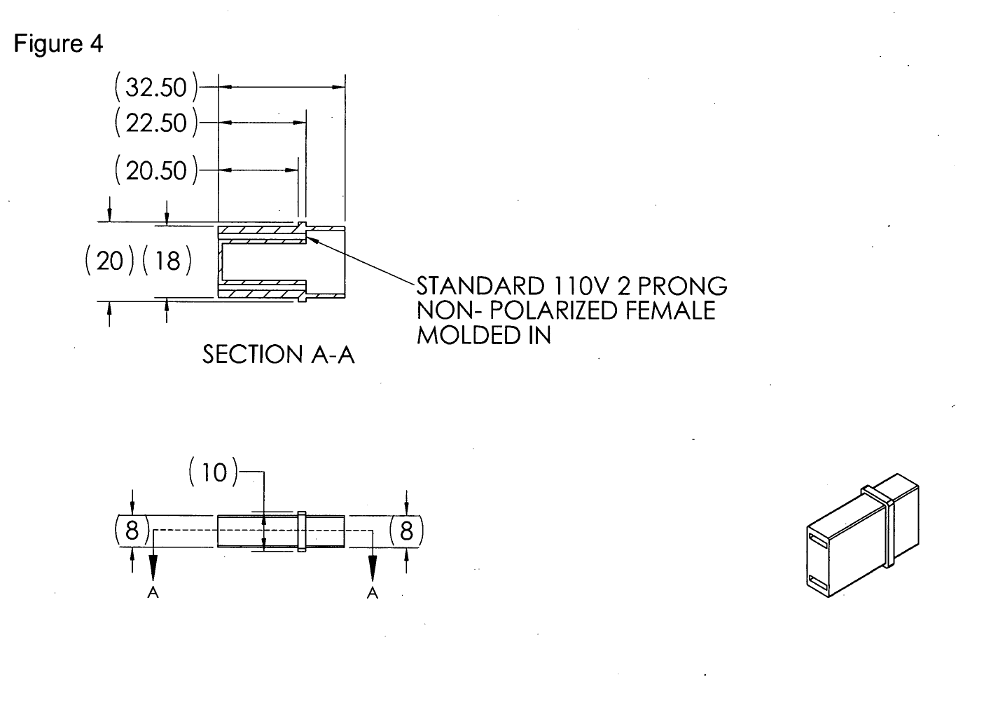

FIG. 5: Three-dimensional male end which inserts into opposite end of rail.

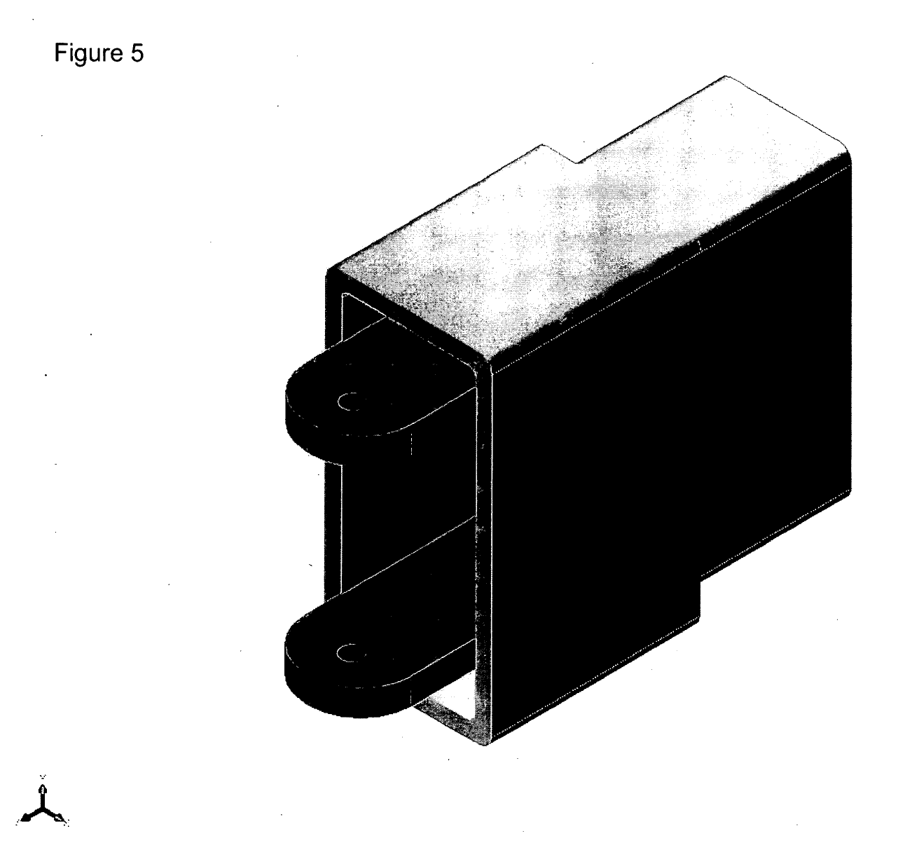

FIG. 6: Two-dimensional male specifications.

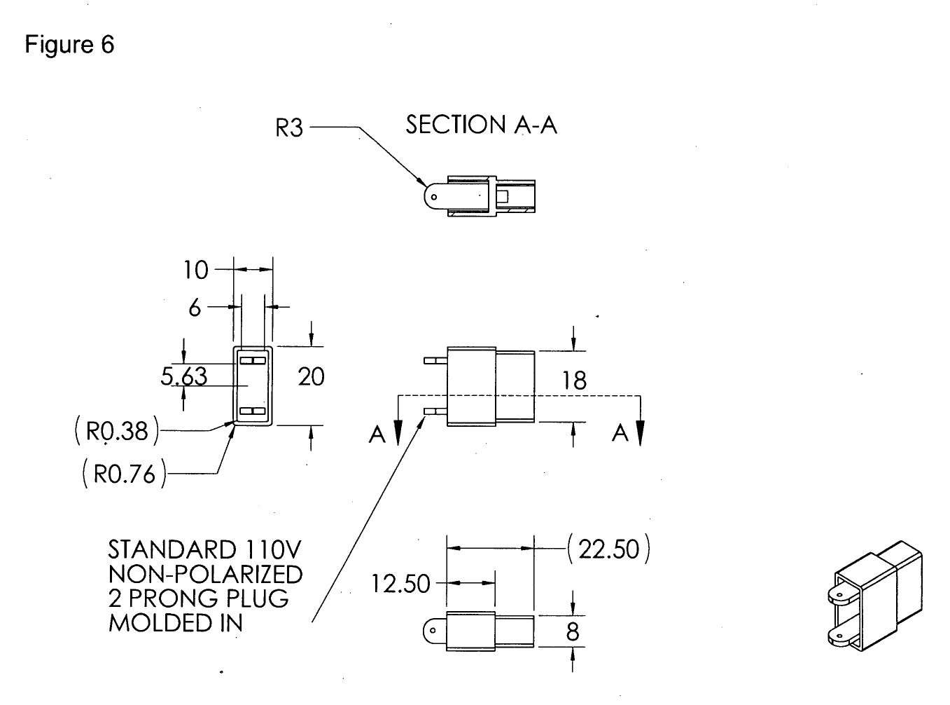

FIG. 7: Three-dimensional female end cap for completing electrical circuit.

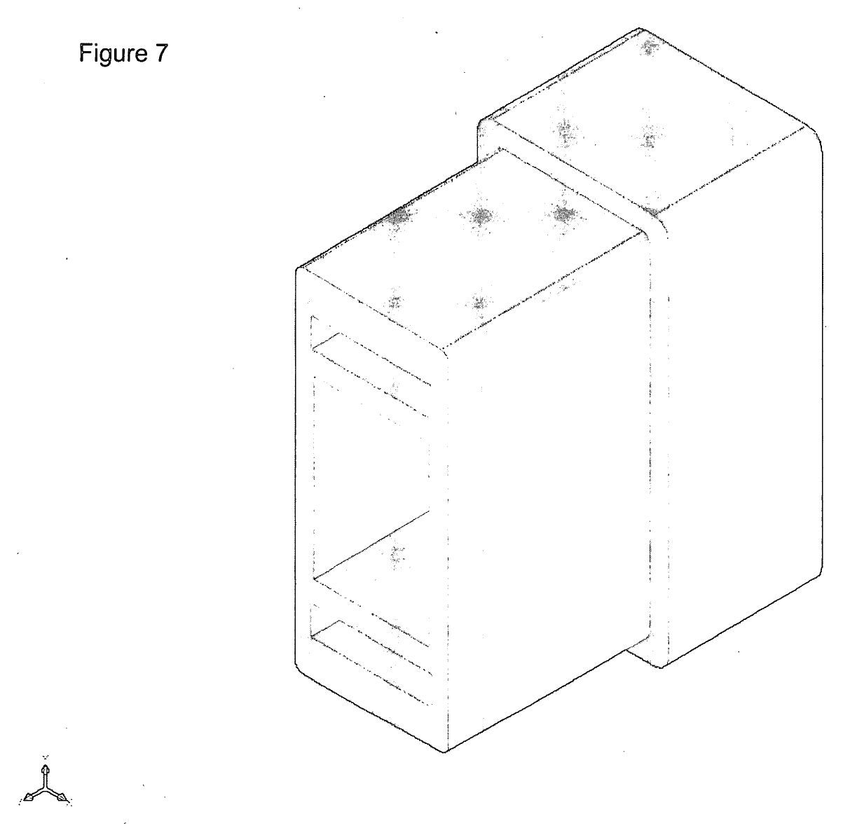

FIG. 8: Two-dimensional female end cap specifications.

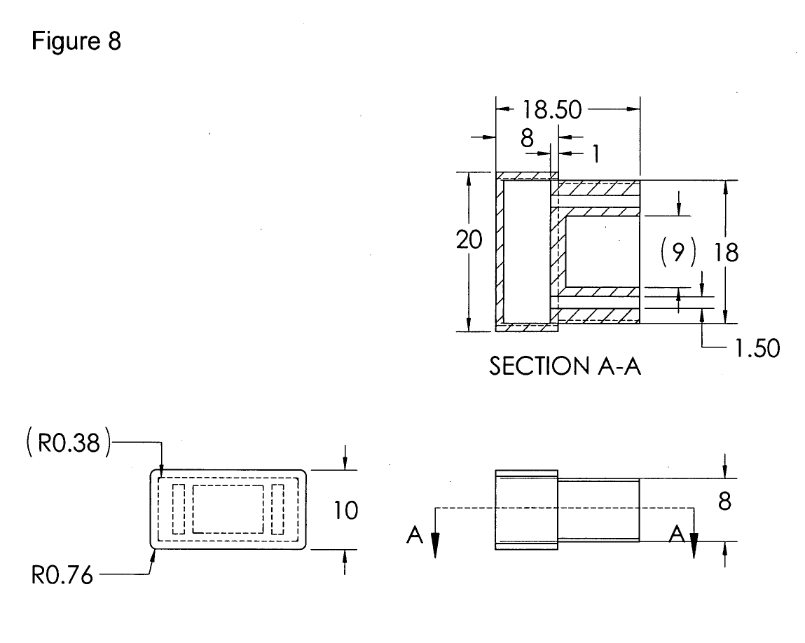

FIG. 9: Male plug specifications for providing power to one end of assembly.

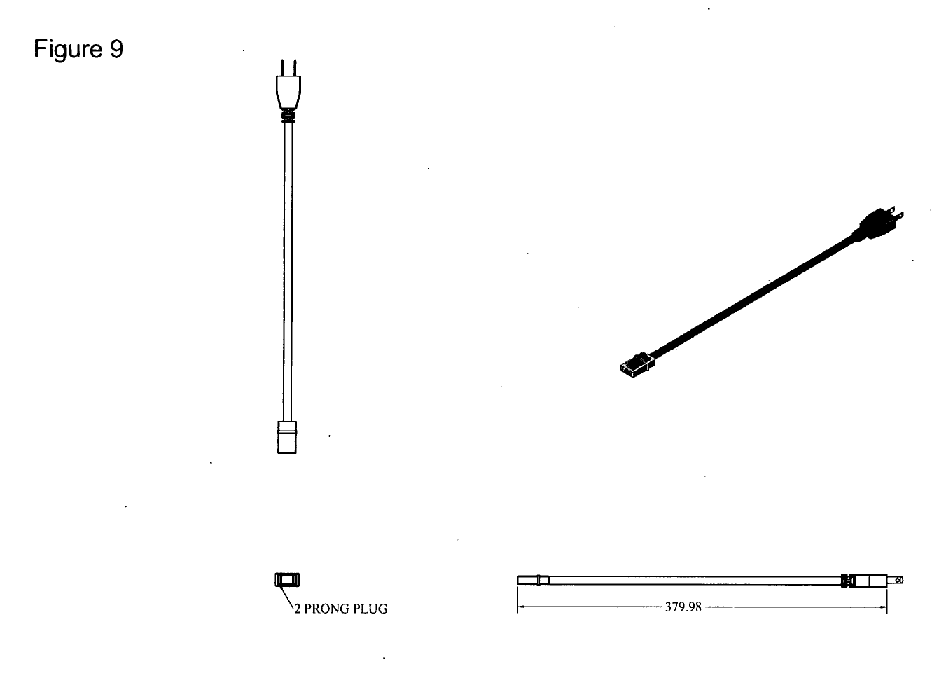

FIG. 10: Base specifications for receiving light bulb.

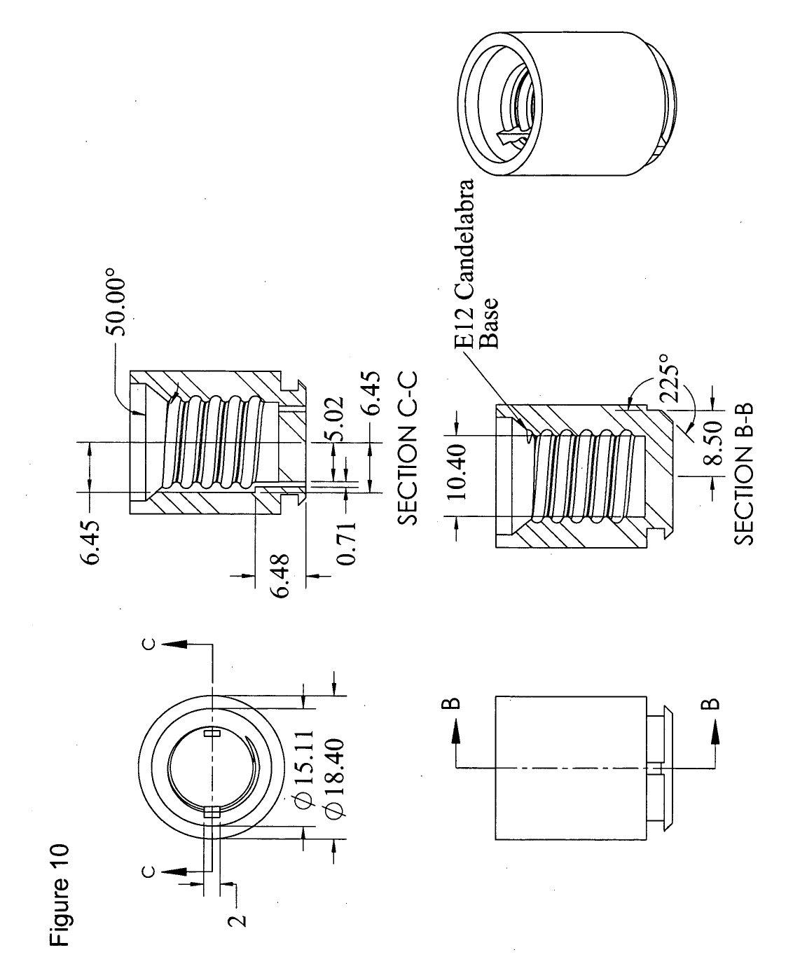

FIG. 11: Three-dimensional permanent mounting bracket.

FIG. 12: Two-dimensional mounting bracket specifications.

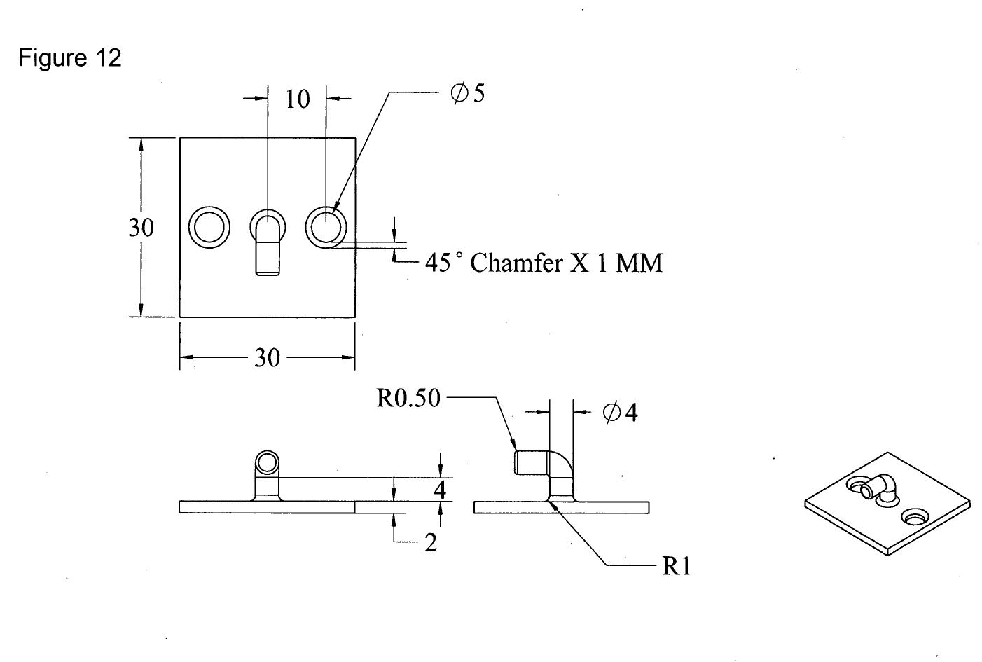

FIG. 13: Three-dimensional “L”-bracket for mounting on flat surfaces such as (but not limited to) the front of a home where no rain-gutter exists.

FIG. 14: Two-dimensional “L”-bracket specifications.

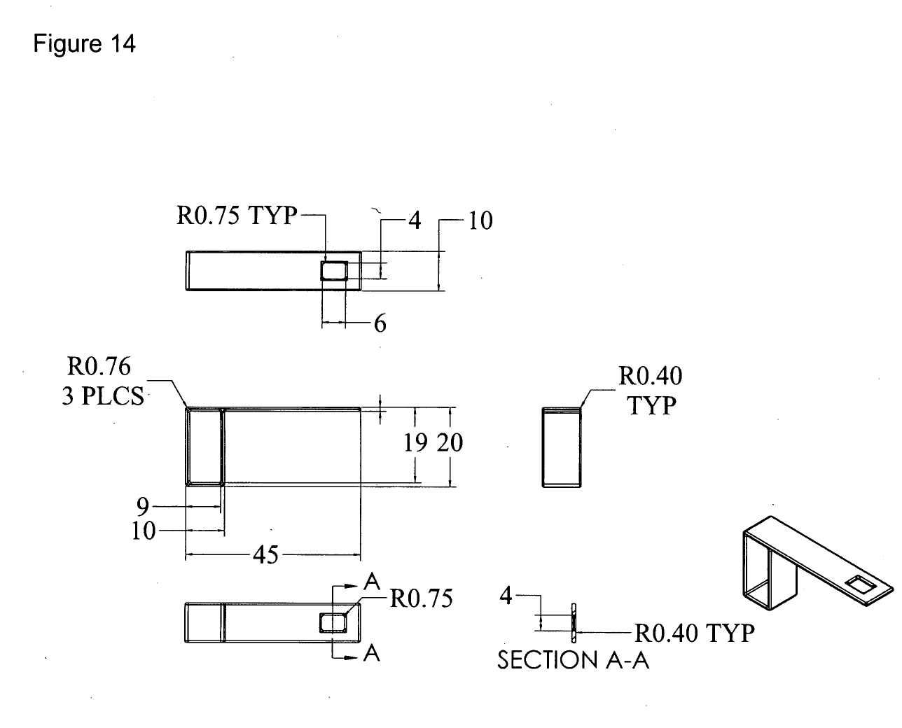

FIG. 15: Three-dimensional “U”-bracket for mounting on a surface such as (but not limited to) a raingutter.

FIG. 16: Two-dimensional “U”-bracket specifications.

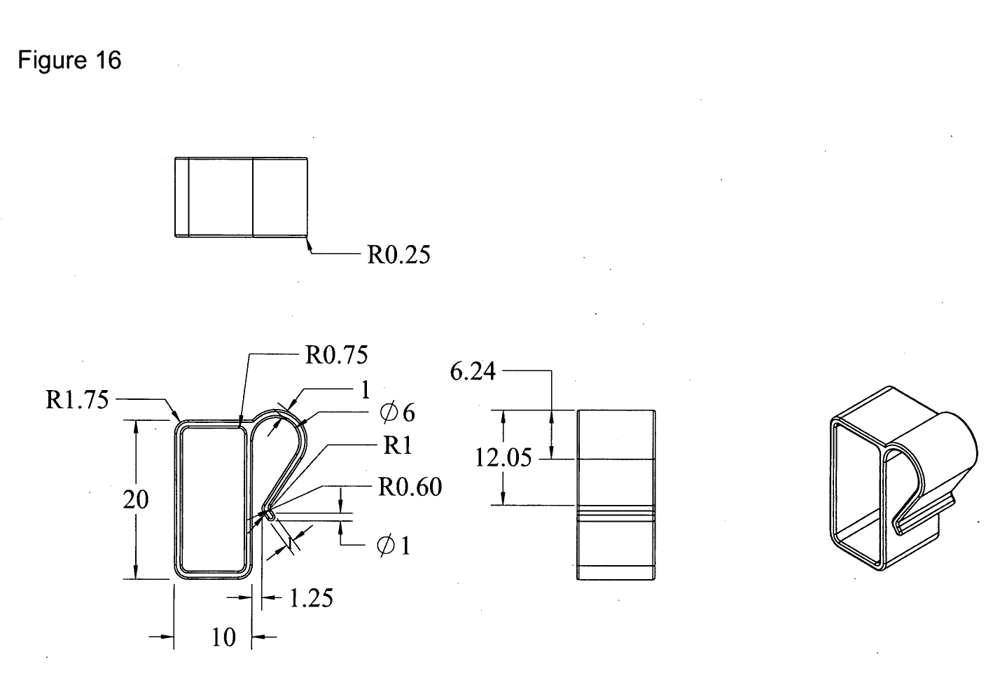

FIG. 17: Three-dimensional “hinged” bracket for installing on ridged surfaces.

FIG. 18: Two-dimensional “hinged” bracket specifications.

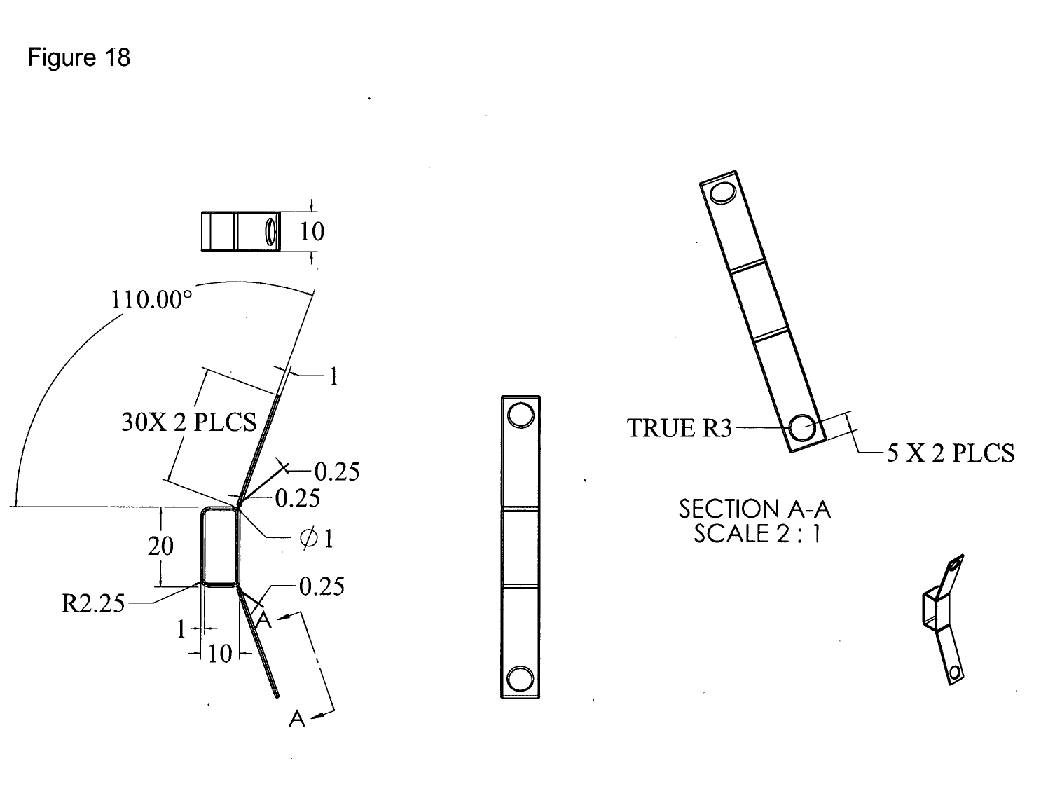

FIG. 19: Three-dimensional spacer for use when no bracket is necessary.

1. The complete system of interlocking components, end caps plugs, sockets, mounting brackets, connectors, integrated wiring and rigid or semi-rigid rails, channels or frames together comprising a simplified means of hanging direct, decorative lighting.

2. Furthermore, any subset of the items in claim 1 when used to create an interlocking system of components for use as direct decorative lighting.

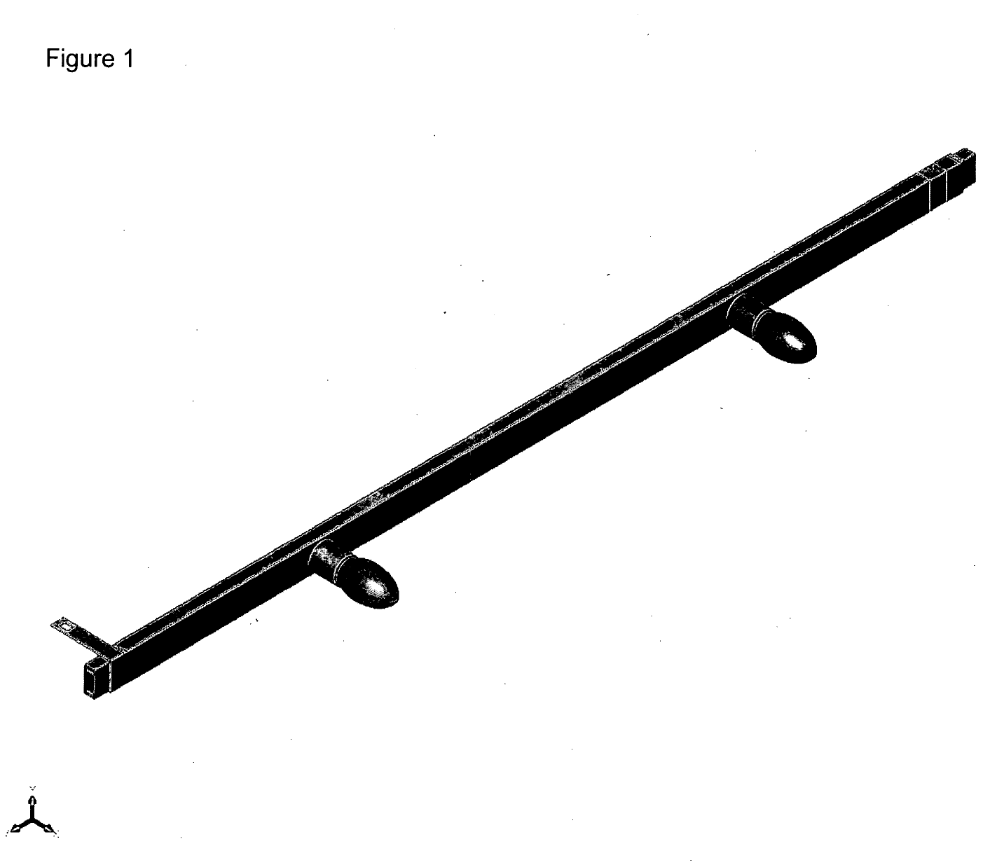

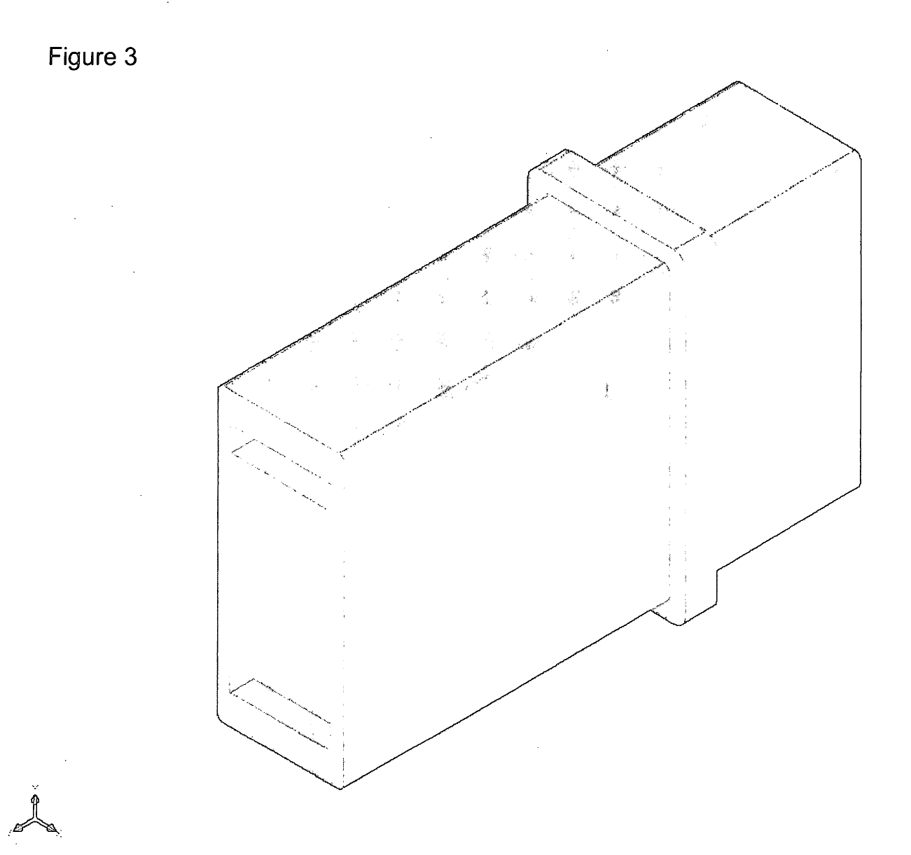

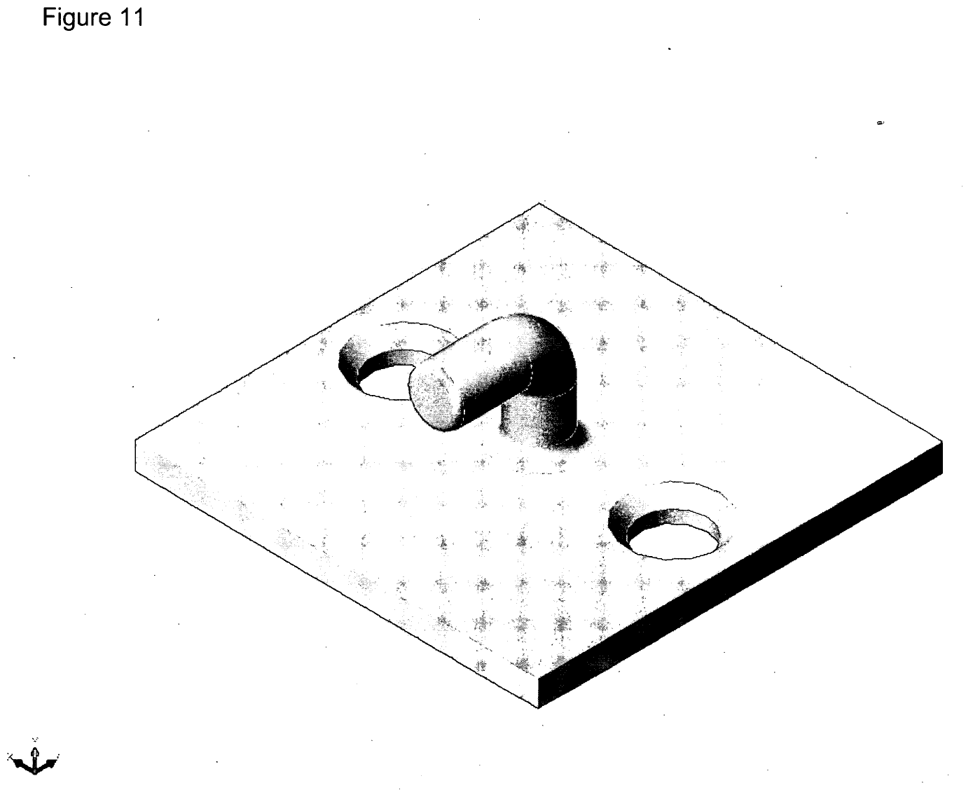

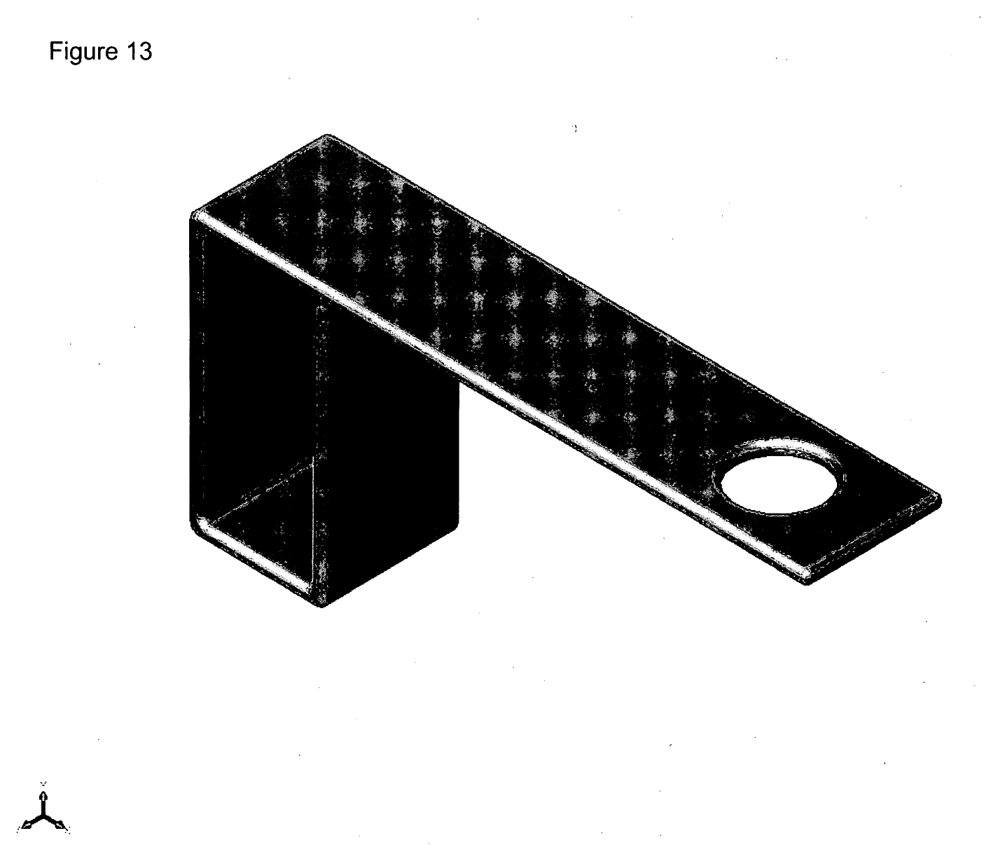

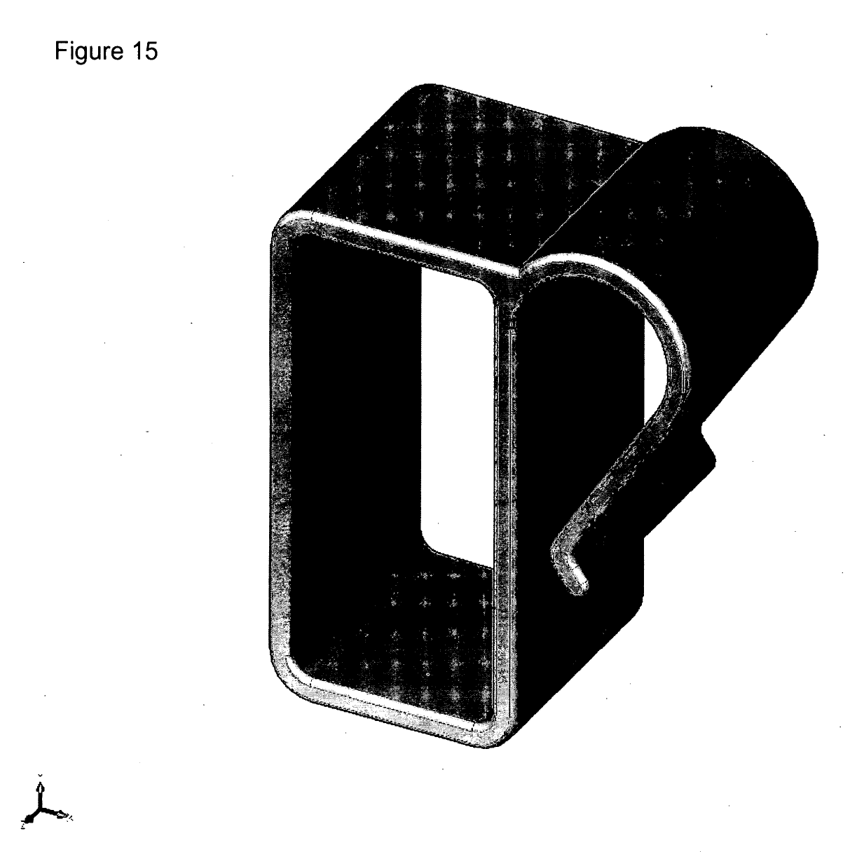

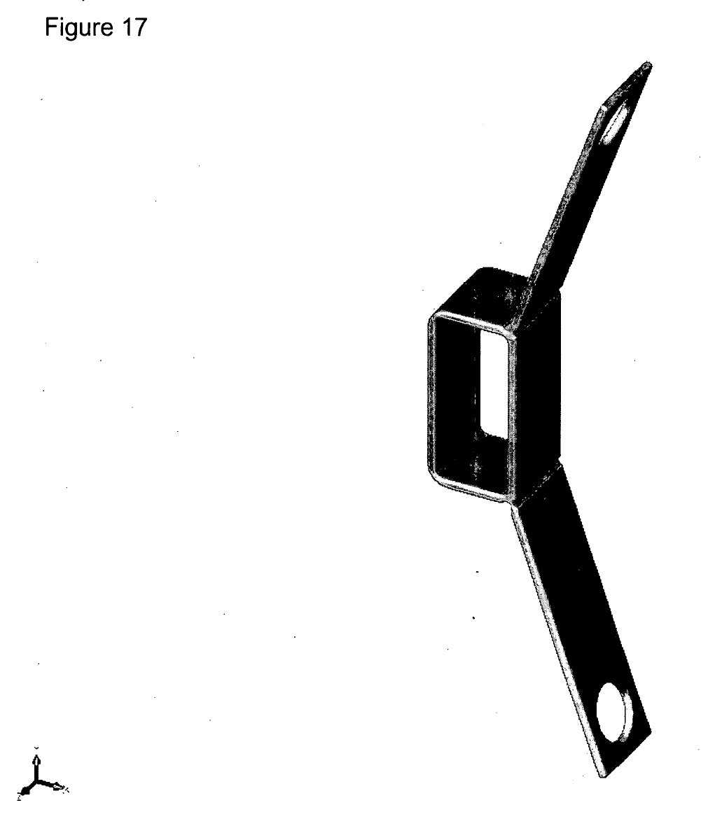

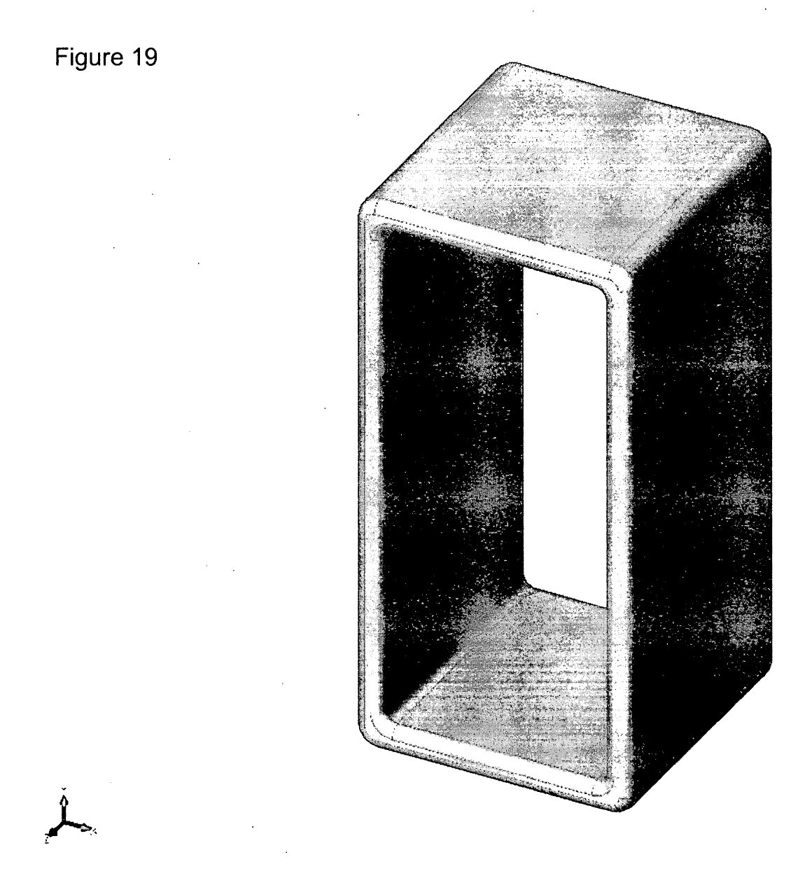

3. Furthermore, each individual component when used for the purpose of a system of components for simplified, direct, decorative lighting including: Rigid or semi-rigid rails, channels or frames designed such that they can be connected end-to-end (via rigid, semi-rigid or flexible connectors) in order to provide uniform, direct, decorative lighting such as (but not limited to) those shown in FIG. 1; the end caps, ends, and plugs (with integrated end) such as (but not limited to) those shown in FIGS. 3,5, 7 and 9; the mounting brackets and spacers as shown in FIGS. 11, 13, 15, 17, and 19.
